(19) United States
(12) Patent Application Publication
(10) Pub. No.: US 2006/0105705 A1
(43) Pub. Date: May 18, 2006

(54) Consumer installer repeater for wireless communication

(75) Inventors: Gregory A. Maca, Annandale, NJ (US); Joseph T. Lipowski, Chester, NJ (US)

Correspondence Address: WOOD, HERRON & EVANS, LLP, 2700 CAREW TOWER, 441 VINE STREET, CINCINNATI, OH, 45202, US

(73) Assignee: Andrew Corporation

(21) Appl. No.: 10/989,788

(22) Filed: Nov. 16, 2004

(51) Int. Cl. H04B 7/15

(52) U.S. Cl. 455/11.1; 455/41.2

(57) ABSTRACT

A consumer repeater for use in a structure comprises a donor unit with a communication antenna, the donor unit configured for communicating with a remote location within a communication band. A broadcast unit with a communication antenna is configured for communicating with a device that is located in or proximate to the structure also within the communication band. A wireless link is coupled between the donor unit and the broadcast unit and is operable for communicating therebetween, the wireless link operating in an FM format.

### FIELD OF THE INVENTION

This invention relates generally to wireless communications and, more specifically, to repeaters for such wireless communications.

### BACKGROUND OF THE INVENTION

Various mobile and wireless communication services, such as cellular telephone services, have become a part of everyday life. While, generally, wireless services, such as cellular telephone services, have been used primarily for voice and data communication in an outdoor mobile environment, indoor usage is desired, as well. Many consumers have even gone so far as considering eliminating typical land-line telephone services in favor of wireless services in their homes. Accordingly, for many wireless customers, it has been increasingly desirable to obtain clear wireless signals within a home or residence.

Such a ubiquitous use of wireless services is certainly desirable for service providers. However, existing wireless networks do not reach in the many indoor environments. If reliable service could be offered to more indoor environments, service providers could seriously compete with conventional wire line or land-line operators. The provision of reliable wireless communication services within a customer's home or residence has presented several problems. Among these problems is maintaining adequate signal gain strength within the residence to adequately communicate with a remote location, such as a remote cell tower. One particular solution developed to extend wireless coverage into indoor environments is the RF repeater. The repeater essentially repeats a signal, such as a signal from a cell tower, and may be located to specifically repeat it into an indoor area, such as a building or house.

Generally, a repeater consists of two antennas and a bi-directional amplifier so that it is able to repeat not only signals from a cell tower to a mobile wireless device (downlink), but also the signals from the mobile device to the cell tower (uplink). That is, one of the antennas of the repeater communicates with the cellular base station or tower, and the other communicates with the user's mobile device, such as a cellular phone or other wireless device. Some repeaters incorporate all the antennas and amplifiers and other electronics within a single housing, with the repeater antenna communicating with the remote base station or tower being positioned to have a good line of sight with such remote location. Alternatively, some repeaters utilize separate antennas wherein the antenna that communicates with the base station is placed outdoors where cellular coverage is good and is connected with the rest of the system with a long coaxial cable.

While such repeater systems can adequately provide wireless coverage indoors, they are generally complex and require installation expertise. For example, the installation of various such repeater systems are often beyond the capabilities of the general household consumer because the coaxial cable needs to be routed through one or more walls to extend from the outside of the home or structure into the inside, where the indoor antenna is located.

Therefore, there is still a need for a system to provide indoor wireless coverage, such as in a home. There is a further need for such a system that can be installed by the average consumer and can extend or repeat the wireless network from an outdoor environment to an indoor environment, such as inside a home.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 illustrates a schematic diagram of a repeater system in accordance with the present invention.

FIG. 2 illustrates a perspective view of a repeater system in accordance with the present invention.

### DETAILED DESCRIPTION

The present invention provides a repeater that may be readily used by consumers for providing wireless communication within a structure, such as a house. The consumer repeater of the invention is readily and conveniently installed and operated. In that way, it can be installed and used by the average consumer without significant building retrofitting, or the routing of cables through the walls. Furthermore, the consumer repeater of the invention is less susceptible to interference, such as WI-FI interference.

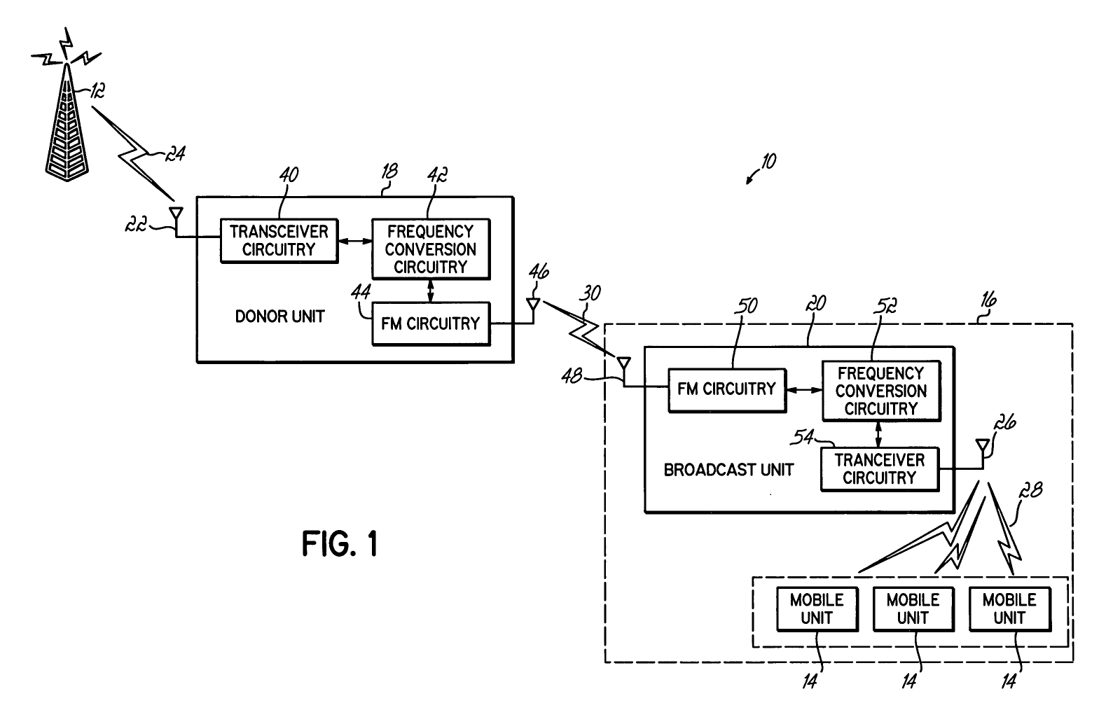

Referring now to FIG. 1, that figure illustrates the components of one embodiment of a consumer repeater in accordance with the principles of the present invention. A consumer repeater as described herein can have commercial, as well as residential uses. Generally, the consumer repeater 10 provides a link between a remote location, such as a base transceiver station (BTS) 12 or other antenna and various mobile units 14. The mobile units, which are normally configured to interface directly with the BTS 12 may be located in a structure 16, such as a house, and thereby shielded from the BTS 12. The remote location is not limited to a BTS 12, but could be any other transmitting system, including another repeater or other wireless system. Furthermore, while the mobile units 14 might predominantly be mobile telephones, they could be other units, such as PDAs or hand-held computers, for example. Furthermore, the units 14 in the structure 16 do not necessarily have to be mobile and might include a desktop or laptop computer that is coupled to the specific system, or service provider that is associated with the BTS 12.

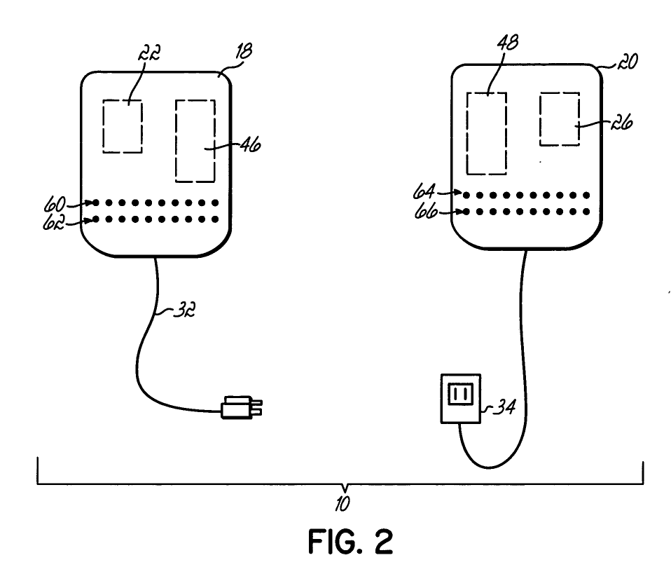

The consumer repeater 10 includes a donor unit 18 that communicates with a broadcast unit 20. The donor unit 18 includes a communication antenna 22 for communicating with the remote location 12 in an available wireless format 24. Antenna 22 could be any suitable antenna including an array of antenna elements. Preferably, the antenna or antenna system is sized to conveniently fit on a movable housing for the donor unit (See FIG. 2). The wireless format 24 might include typical wireless formats that utilize, for example, a PCS, GSM, or CDMA band.

The broadcast unit includes a similar communication antenna 26, which communicates with various mobile units 14 through wireless format 24, 28. Typically, the wireless formats 24 and 28 are the same such that, in effect, the consumer repeater 10 essentially extends the coverage of the BTS 12 into the house or other structure 16 containing the broadcast unit. Outside the structure 16, and closer to the BTS 12, the mobile units 14 would normally communicate directly with the BTS 12. In one embodiment, the broadcast unit is positioned inside the structure 16 and the donor unit is positioned outside. However, other arrangements, such as both units inside the structure or both units positioned outside the structure might also be utilized as long as the donor unit can adequately communicate with the BTS 12 and the broadcast unit can communicate with the mobile units 14.

In accordance with one aspect of the present invention, the donor unit 18 and broadcast unit 20 have a wireless link 30 coupled therebetween. The wireless link 30 is operable for communicating between the donor unit 18 and broadcast unit 20 and thereby eliminates the necessity of routing cables between the donor and broadcast units through the walls of the structure 16. This provides a significant benefit over prior repeaters. First, because the broadcast unit may be positioned separately from the donor unit, the broadcast unit may be positioned in the structure to provide the best coverage. Other repeaters utilize a single housing. Next, the present invention does not require cables to route signals to the less accessible or more shielded areas within the structure 16. In the present invention and as illustrated in FIG. 2, the donor unit 18 is configured as an outdoor unit in one embodiment, and may be positioned outside of the structure 16 and exposed to the elements. Power might be supplied by a plug-in cord and plug 32, which is also suitable for use outdoors. The broadcast unit, which is designated as the indoor or in-structure unit 20, is positioned where desired in the structure, and then might be coupled to a suitable power source, such as the unit being plugged into a wall. The broadcast unit 20 might include a wall transformer 34 for providing the necessary power signals for operating the broadcast unit and the electronics therein.

Referring again to FIG. 1, a schematic diagram of each of the units is illustrated. The donor unit 18 communicates with the device at a remote location, such as BTS 12 through communication antenna 22. Antenna 22 is coupled to appropriate transceiver circuitry 40 capable of transmitting and receiving RF signals within the appropriate communication band 24, 28. For example, in explaining the embodiment, we will assume that the communication band is a PCS band, although other suitable bands may be utilized. Transceiver circuitry 40, therefore, receives and transmits PCS signals. To that end, the transceiver circuitry 40 may include amplification circuitry (not shown), such as a low noise amplifier (LNA) and/or a power amplifier (PA) for amplifying the received and transmitted signals. For the PCS band, the antenna 22 would be configured for PCS communications. The transceiver circuitry 40 may include other appropriate electronic components and circuits (not shown), such as filters or signal splitters and combiners for communication with BTS 12.

In accordance with one aspect of the invention, a wireless link 30 is coupled between the donor unit 18 and the broadcast unit 20, and is operable for communicating therebetween, as noted above. The wireless link 30 operates in a frequency modulation or FM format. The donor unit 18 includes frequency conversion circuitry. The frequency conversion circuitry 42 converts the downlink signals in the donor unit 18 between the PCS band, for example, and a baseband frequency. The analysis of a downlink signal from BTS 12 to the donor unit 18 and ultimately to the mobile units will be described herein as an example. An uplink signal traveling from the mobile units to the BTS would be somewhat similarly processed, except in the other direction.

Frequency conversion circuitry 42 downconverts the PCS signal received from the BTS to a baseband signal. The downconverted PCS signal, or baseband signal, is then used by FM circuitry 44 to modulate a carrier signal to produce an FM signal that, in the downlink, is then sent out over a link antenna 46. The link antenna 46 of the donor unit 18 is coupled by the wireless link 30 with a link antenna 48 of the broadcast unit 20. In one embodiment of the FM signal, the wireless link may be a 20 MHz wide FM signal.

Significant advantages are achieved with the wireless link 30 operating in an FM format between the donor unit and the broadcast unit of the consumer repeater 10. The detection of interference in the FM format is robust. For example, within a structure, interference may pop up in the form of WI-FI signals, such as 802.11A interference that interferes with the wireless link 30 between the link antennas 46, 48. Furthermore, the FM format allows for lower cost amplifiers without linearity requirements. For example, Class C amplifiers might be utilized. Still further, an advantage is offered in that signals may be multiplexed in the FM format. In one embodiment of the invention, three channels are multiplexed on the wireless link 30. For example, the original PCS channel, or information channel, might be coupled with a data channel for communicating protocol between the circuitry that allows the donor unit 18 and broadcast unit 20 to talk to each other. Furthermore, a reference channel, such as a 10 MHz pilot tone, might also be multiplexed in the wireless link to set frequency references in both of the donor and broadcast units to be generally the same frequency. Therefore, the present invention offers significant improvements over the prior art and has significant advantages when the wireless link is operated in the FM format in accordance with the principles of the present invention.

The signals 24, 28 handled and repeated by the consumer repeater 10 may be for a single service provider such that the repeater would operate exclusively for that single service provider. Alternatively, multiple providers might be serviced by the consumer repeater 10. For example, each provider may have a 5 MHz section of the PCS band or other communication band that is utilized. The transceiver circuitry 40 may be appropriately configured for addressing each of the 5 MHz bands for a service provider in that case.

In accordance with one aspect of the present invention, the wireless link operates in an FM format having a carrier signal in a specific band, which would not interfere with the communication band, such as the PCS band. Specifically, the carrier signal may operate an industrial, scientific, and medical (ISM) radio band, or in an unlicensed national information infrastructure (UNII) radio band. For example, the 900 MHz band and 2.45 GHz bands might be utilized for the wireless link. Alternatively, the 5 GHz band, which utilizes a 5.7 GHz downlink and a 5.2 GHz uplink, might also be utilized for the wireless link. The carrier signal in the selected band for the wireless link 30 is then modulated utilizing the downconverted baseband PCS signal from the frequency conversion circuitry 42.

Referring now to the broadcast unit, the broadcast unit utilizes somewhat similar circuitry components as the donor unit. The FM circuitry 50 is coupled to the link antenna 48 and communicates through the wireless link 30. The circuitry 50, in the downlink, provides a demodulated baseband signal that is then upconverted by frequency conversion circuitry 52. The upconverted signal, such as the PCS signal, is then further handled by the transceiver circuitry 54 and then broadcast with the communication antenna 26 to the various mobile units 14. Generally, the broadcast unit 20 will include appropriate amplifiers, such as in the transceiver circuitry, for amplifying the signal 28 for transmission to the mobile units 14. In that way, downlink information coming from the BTS 12 is repeated within a structure and sent as a strong signal to the various mobile units 14 to increase coverage of the PCS or other communication band signal 24, 28 within structure 16.

The uplink proceeds in the opposite direction. The mobile units 14 send their information to the communication antenna 26 of the broadcast unit where it is processed, downconverted, and then turned into an FM signal by the FM circuitry 50. It is then sent by a wireless link to the donor unit and demodulated, upconverted, and broadcast on antenna 22 through the transceiver circuitry 40 to the BTS 12.

Referring to FIG. 2, various features might be added to the consumer repeater to assist in its installation and operation. For example, the donor unit 18 may include an indicator 60 for indicating the strength of the downlink received signal from the BTS. In that way, the donor unit 18 may be steered or positioned so that the communication antenna 22 receives a strong (downlink) signal from the remote location 12. Another indicator 62 may be utilized to indicate the gain or boost of the downlink signal that is provided by the repeater circuitry when it is transmitted to the broadcast unit. That is, the consumer repeater of the present invention through appropriate amplification circuitry (not shown) will amplify the downlink and uplink signals between the BTS 12 and mobile units 14.

Similarly, the broadcast unit may include an indicator 64 for indicating the strength of the uplink received signal, such as the signals 28 from the mobile units 14. Such an indicator may be utilized for locating the broadcast unit. Alternatively, an indicator 66 may be incorporated into the broadcast unit to indicate the gain or amplification of the uplink signal provided by the consumer repeater 10.

Accordingly, the present invention provides a simple and easy to install consumer repeater that can be utilized to provide wireless communication coverage within a structure such as a house. The consumer repeater is readily installed and provides significant advantages over currently existing repeater technology. Furthermore, utilization of an FM format for the wireless link between the various components of the consumer repeater ensure that other wireless signals in a structure, such as WI-FI signals, may be more readily detected as interference and, therefore, more readily addressed. In addition, the FM format allows for lower cost amplifiers, thus reducing the overall cost of the consumer repeater.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicant's general inventive concept.

What is claimed:

1. A consumer repeater for use in a structure, comprising:
a donor unit with a communication antenna, the donor unit configured for communicating with a remote location within a communication band;
a broadcast unit with a communication antenna, the broadcast unit configured for communicating with a device that is located in or proximate to the structure also within the communication band;
a wireless link coupled between the donor unit and the broadcast unit and operable for communicating therebetween, the wireless link operating in an FM format.

2. The repeater of claim 1 wherein the donor unit and broadcast unit are configured for communicating in one of a PCS, GSM or CDMA band.

3. The repeater of claim 1 wherein the wireless link includes a link antenna coupled with the donor unit and a link antenna coupled with the broadcast unit, the link antennas communicating with each other in the FM format.

4. The repeater of claim 1 wherein the wireless link operates in an FM format having a carrier signal in at least one of an ISM band or a UNII band.

5. The repeater of claim 1 wherein the wireless link includes circuitry positioned in the donor unit and the broadcast unit, the circuitry operable for downconverting signals in the communication band to baseband signals and for using the downconverted signals to modulate a carrier signal in the FM format.

6. The repeater of claim 1 wherein the wireless link utilizes a signal around 20 MHz wide in the FM format.

7. The repeater of claim 1 wherein the wireless link includes an information signal, a data signal and reference signal that are multiplexed to the link antennas for communication between the donor unit and broadcast unit.

8. The repeater of claim 1 wherein the broadcast unit includes an indicator to indicate the strength of the signal received from the device.

9. The repeater of claim 1 wherein the broadcast unit includes an indicator to indicate the gain provided to the signal received from the device.

10. The repeater of claim 1 wherein the donor unit includes an indicator to indicate the strength of the signal received from the remote location.

11. The repeater of claim 1 wherein the donor unit includes an indicator to indicate the strength of the signal received from the remote location.

12. The repeater of claim 1 wherein the donor unit is configured for being positioned outdoors.

13. The repeater of claim 1 wherein the communication antennas are patch antennas.

14. The repeater of claim 3 wherein the link antennas are patch antennas.

15. The repeater of claim 1 wherein the donor and broadcast units are configured for communicating signals of a plurality of service providers, each having a section of the communication band.

16. The repeater of claim 1 wherein the donor and broadcast units are configured for communicating signals of a single service provider.

17. A consumer repeater for use in a structure, comprising:
a donor unit with a communication antenna, the donor unit configured for communicating with a remote location within a communication band including one of a PCS, GSM and CDMA band;
a broadcast unit with a communication antenna, the broadcast unit configured for communicating with a device that is located in or proximate to the structure also within the communication band;
a wireless link coupled between the donor unit and the broadcast unit and operable for communicating therebetween, the wireless link operating in an FM format.

18. The repeater of claim 17 wherein the wireless link operates in an FM format having a carrier signal in at least one of an ISM band or a UNII band.

19. The repeater of claim 17 wherein the wireless link includes circuitry positioned in the donor unit and the broadcast unit, the circuitry operable for downconverting signals in the communication band to baseband signals and for using the downconverted signals to modulate a carrier signal in the FM format.

20. The repeater of claim 17 wherein the donor and broadcast units are configured for communicating signals of a plurality of service providers, each having a section of the communication band.

21. The repeater of claim 17 wherein the donor and broadcast units are configured for communicating signals of a single service provider.

22. A consumer repeater for use in a structure, comprising:
a donor unit configured for communicating with a remote location within a communication band;
a broadcast unit configured for communicating with a device that is located in or proximate to the structure also within the communication band;
the donor unit and the broadcast unit being operable for communicating with each other in an FM format.

23. The repeater of claim 22 wherein the donor unit and broadcast unit are configured for communicating in one of a PCS, GSM or CDMA band.

24. The repeater of claim 22 wherein the FM format has a carrier signal in at least one of an ISM band or a UNII band.

25. The repeater of claim 22 further comprising circuitry positioned in the donor unit and the broadcast unit and operable for downconverting signals in the communication band to baseband signals and for using the downconverted signals to modulate a carrier signal in the FM format.

26. The repeater of claim 22 wherein the donor and broadcast units are configured for communicating signals of a plurality of service providers, each having a section of the communication band.

27. The repeater of claim 22 wherein the donor and broadcast units are configured for communicating signals of a single service provider.

28. A method of repeating a wireless communication signal in a structure, comprising:
with a donor unit having a communication antenna, communicating with a remote location within a communication band;
with a broadcast unit with a communication antenna, communicating with a device that is located in or proximate to the structure also within the communication band;
communicating between the donor unit and the broadcast unit with a wireless link operating in an FM format.

29. The method of claim 28 further comprising communicating between the donor unit and broadcast unit in one of a PCS, GSM or CDMA band.

30. The method of claim 28 further comprising communicating in the FM format with a link antenna coupled with the donor unit and a link antenna coupled with the broadcast unit.

31. The method of claim 28 wherein the wireless link operates in an FM format having a carrier signal in at least one of an ISM band or a UNII band.

32. The method of claim 28 further comprising downconverting signals in the communication band to a baseband signals and using the downconverted signals to modulate a carrier signal in the FM format.

33. The method of claim 28 wherein the wireless link includes an information signal, a data signal and reference signal that are multiplexed to the link antennas for communication between the donor unit and broadcast unit.

34. The method of claim 28 wherein the donor and broadcast units are configured for communicating signals of a plurality of service providers, each having a section of the communication band.

35. The method of claim 28 wherein the donor and broadcast units are configured for communicating signals of a single service provider.
